(19) United States
(12) Patent Application Publication
(10) Pub. No.: US 2013/0001191 A1
(43) Pub. Date: Jan. 3, 2013

(54) REDEPOSITION TECHNIQUE FOR MEMBRANE ATTACHMENT

(75) Inventors: Ken Guillaume Lagarec, Gatineau (CA); Michael William Phaneuf, Ottawa (CA); Michael Anthony Anderson, Ottawa (CA)

(73) Assignee: FIBICS INCORPORATED, Ottawa, ON (CA)

(21) Appl. No.: 12/161,426

(22) PCT Filed: Jan. 19, 2007
(86) PCT No.: PCT/CA2007/000074

§ 371 Date: Nov. 29, 2010

Related U.S. Application Data
(60) Provisional application No. 60/759,960, filed on Jan. 19, 2006.

(51) Int. Cl. B44C 1/22; B32B 37/02

(52) U.S. Cl. 216/33; 216/66

(57) ABSTRACT

A method for securing a micro-object to a substrate by redeposition. The method includes ion-beam milling the substrate in proximity of the micro-object such that the material milled away from the substrate sprays onto the micro-object and covers its base, effectively attaching it to the substrate. Since no carrier gases are used, the ion beam chamber and its contents are not exposed to undesirable contaminants.

### CROSS REFERENCE TO RELATED APPLICATIONS

This application claims the benefit of priority of U.S. Provisional Patent Application No. 60/759,960 filed Jan. 19, 2006, the entire contents of which are incorporated herein by reference.

### FIELD OF THE INVENTION

The present invention relates generally to focused ion beam (FIB) systems. More particularly, the present invention relates to securing micro-objects to a substrate by using an FIB system.

### BACKGROUND OF THE INVENTION

Focused ion beam (FIB) systems have become valuable tools in the production of specimens for transmission electron microscopy (TEM) in the semiconductor and materials sciences as well as in the life sciences. The “nanomachining” capability of FIB systems, combined with the use of manipulator or transport tools, allows the removal of a small section of a material for TEM analysis, leaving the remainder of the material intact. The small section removed from the material is typically referred to as a specimen, membrane, volume or sample.

Typical approaches to FIB-based TEM specimen preparation, including the use of a so-called lift-out tool, are discussed in, for example, Introduction to Focused Ion Beams: Instrumentation, Theory, Techniques and Practice, Lucille A. Giannuzzi and Fred A. Stevie, Eds., Springer, New York, 2005 ISBN 038723116-1.

Typical methods of performing in-situ lift-out of a specimen or volume for TEM investigation involve using an FIB system and gas-assisted deposition of a material. For example, FIB deposited metals, e.g. tungsten or platinum, or non metallic FIB deposited materials, e.g. carbon or silicon oxide, can be used to attach a specimen, or a volume from which a specimen will be produced, to a transport tool and/or carrier grid that can be inserted into the TEM system. A region of the host material from which the specimen is to be taken is nanomachined by the FIB to define a small volume that contains the region of interest that will ultimately become a TEM specimen. Subsequently, the FIB is used to attach a transport tool, e.g. a transport needle, to the small volume through gas-assisted material deposition, whereby the ion beam is rastered over a region that overlaps both the tip of the transport needle and a portion of the small volume. The interaction of the FIB with the deposition gas leads to the deposition of material over the region that is rastered by the ion beam, thereby attaching the nanomachined small volume to the transport tool.

The FIB is then used to completely mill the perimeter of the rastered region to free the specimen from the host material. Once attached to the transport tool, the transport tool moves the specimen to a TEM grid where, once again, FIB gas-assisted material deposition is used to attach the specimen to the grid. The transport tool is then detached from the specimen.

These methods always rely on the deposited material to originate from a carrier gas that decomposes in the presence of the ion beam. For example, in the case of FIB deposited tungsten, tungsten carbonyl is used as a carrier gas to deposit a volume of material containing tungsten on the specimen surface. Unfortunately, the carrier gas floods the entire FIB system chamber and may decompose or adsorb over undesirable regions of the host material and over other samples present in the FIB system chamber, thereby leading to sample contamination. This is particularly undesirable in cases where FIB systems are used in industrial semiconductor fabrication facilities to examine partially processed wafers and where contamination can affect subsequent downstream manufacturing of the target wafer as well as the manufacturing lines themselves.

Other methods used in the preparation of specimens for TEM analysis forgo the step of depositing a material on the specimen area in order to attach the transport tool to the specimen. Instead, these method use a micro-electromechanical (MEMS) manipulator device to remove the milled-out specimen and to transport the specimen to the TEM grid. However, as in the method described above, in a subsequent step the specimen is still attached to the TEM grid using FIB gas-assisted material deposition. In both types of methods, the securing of the specimen to a grid allows the specimen and grid to be removed from the FIB system chamber and brought to a TEM analysis chamber. However, the requirement of using FIB gas-assisted material deposition to attach the specimen to the grid introduces the potential for contamination.

Still other methods of securing the specimen involve the use of a mechanical “force fit” of the specimen or the volume of interest that includes the specimen (and will be subsequently nanomachined to produce the specimen) into a mechanical holder or grid. This method may not require the use of FIB gas assisted deposition, however the act of physically inserting the specimen into the force-fit holder can cause stress on the specimen, the stress creating undesirable artifacts. For example, when attempting to produce a TEM specimen from a region containing a corroded grain boundary, the force required to achieve the necessary force fit attachment can tear open the grain boundary of interest, causing artifacts that affect the subsequent analysis to the point where the analysis may be invalid. A similar effect can sometimes be observed in semiconductor devices with structurally “weak” polymer based “low-k” dielectrics, which cannot withstand the forces required to achieve the force-fit.

In addition to increasing the risk of contamination, gas-assisted metal deposition requires the insertion and removal of a gas nozzle in the FIB system chamber, in proximity to the sample from which the specimen is taken and to the substrate on which the specimen is to be attached. This contributes to vibration as well as more stringent limits on sample geometries and positioning. If the sample height is not properly set, the gas nozzle can crash into the sample and destroy it. As well, proper adjustment of the gas flow is necessary to obtain the proper conditions for deposition.

Therefore, it is desirable to provide a method of fabricating TEM specimens that does not use gas-assisted deposition of material yet does not require a force-fit type attachment of the specimen to the carrier

### SUMMARY OF THE INVENTION

It is an object of the present invention to obviate or mitigate at least one disadvantage of previous methods used in fabricating TEM specimens.

In a first aspect, the present invention provides a method of securing a micro-object to a substrate. The method includes placing the micro-object on the substrate; and subjecting a target area of the substrate adjacent the micro-object to an ion beam for removing material from the target area. Some removed material from the target area is thereby redeposited over the micro-object and the substrate to attach the micro-object to the substrate.

According to embodiments of the present aspect, the ion beam can be a focused ion beam (FIB), and the FIB is rastered over the target area in successive steps. The FIB has an associated current and dwell time for each step, the current and dwell time being pre-determined in accordance with material properties of the substrate and with physical characteristics of the micro-object. Furthermore, the FIB rasters the target area starting at a position of the target area closest to the micro-object and ending at another position of the target area furthest from the micro-object, where the dwell time for each step can be at least 50 μs. Alternately, the target area is rastered in a series of lines, a distance between dwell points in a given line being different from a spacing between consecutive lines. The step of subjecting a target area of the substrate adjacent the micro-object to an ion beam to remove material from the target area, can be repeated for at least one more target area.

According to further embodiments of the present aspect, the micro-object can be a volume of an electron microscopy specimen produced by nanomachining, an electron microscopy specimen, a specimen taken from a semiconductor wafer a micro-electromechanical device or a biological specimen. The substrate can be one of a conductive and a semiconductive substrate, or the substrate can be a metal, boron, boron carbide or silicon.

In a further embodiment of the present aspect, the substrate includes an electrically conductive area and an insulator area. The micro-object is placed at least partly on the electrically conductive area, and the target area includes at least partly the insulator area. The step of placing the micro-object on the substrate can be followed by a step of holding the micro-object on the substrate, and the step of subjecting a target area of the substrate adjacent the micro-object to an ion beam is followed by a step of releasing the micro-object.

In a second aspect, the present invention provides a method of preparing a transmission electron microscopy specimen. The method includes placing the specimen on a substrate; subjecting a target area of the substrate adjacent the specimen to an ion beam for removing material from the target area such that some removed material from the target area is redeposited over the specimen and the substrate to the specimen to the substrate; and subjecting the specimen to the ion beam to remove material obscuring a region of interest of the specimen. In an embodiment of the present aspect, the step of subjecting the specimen to an ion beam can include thinning the specimen to electron transparency.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 shows the top view of a sample;

FIG. 2 shows a side view of the sample of FIG. 1 being milled;

FIG. 3 shows the top view of the sample of FIG. 1 after milling;

FIG. 4 shows the extraction of a specimen from the substrate of FIG. 1;

FIG. 5 shows the binding by redeposition of the specimen of FIG. 4 to a substrate;

FIG. 6 shows the top view of the substrate of FIG. 5 with the specimen secured thereto;

FIGS. 7 and 8 show FIB images of a specimen secured to a substrate; and

FIG. 9 shows a comparison between a prior method of securing a specimen and the method of the present invention.

### DETAILED DESCRIPTION

For the purpose of the description, the term micro-object means any object too small to be manipulated directly by a technician. Such micro-objects include, for example, specimens or volumes taken for any type of solid material, semiconductor devices, biological specimens and micro-electromechanical structures (MEMS).

The present invention provides a method for attaching a micro-object to a substrate or carrier grid, the method being executed in an absence of a gas-assisted material deposition and thus, not exposing the FIB system chamber and its contents to undesirable contaminants.

In order to completely remove the need for material deposition based on a carrier-gas, a transport tool such as a MEMS based manipulator can be used. Such manipulators are available through Zyvex Corporation of Richardson Texas and can be used to grip, transport and release the micro-object in question without the need for physically attaching the gripper to the micro-object through gas-assisted material deposition. Combining such a manipulator with the approach described herein for securing the micro-object to a substrate or a grid removes any risk of contamination of the FIB system chamber through carrier gas-assisted material deposition.

It is not necessary to employ a MEMS based manipulator as the transport tool. A more conventional “needle” tip can be attached to the micro-object and transferred to the carrier grid for subsequent attachment to the grid, in general as is performed in the art, with the added innovation of employing the proposed method to perform both the attachment of the needle tip to the micro-object and the attachment of the micro-object to the carrier grid.

In addition to avoiding contamination sources, the proposed method removes the need to insert and retract a gas injection nozzle in the FIB system chamber, thereby avoiding vibrations and the risk of damage to the sample.

The proposed method can be used to secure any type of micro-object to any type of material. For example, such micro-objects can include specimens obtained from host materials through milling or cleaving or any other suitable means. Micro-objects can also include, for example, portions of semiconductor devices, biological specimens and MEMS devices. The material to which the micro-object is secured can include, for example, semiconductors, dielectrics or metals.

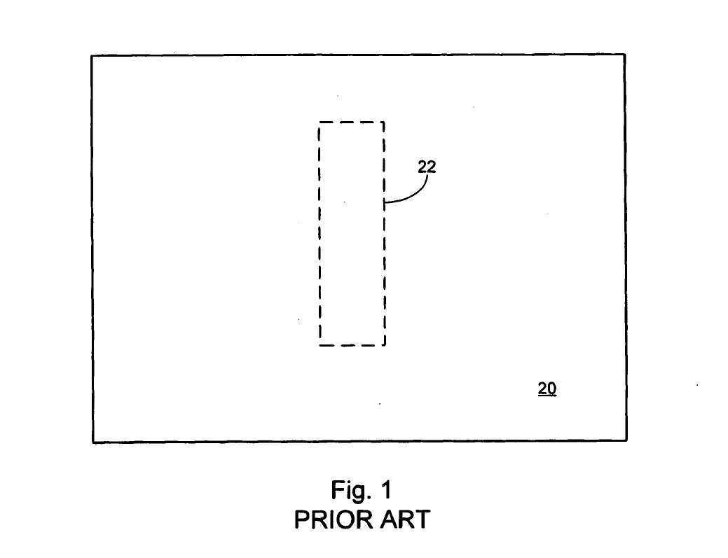

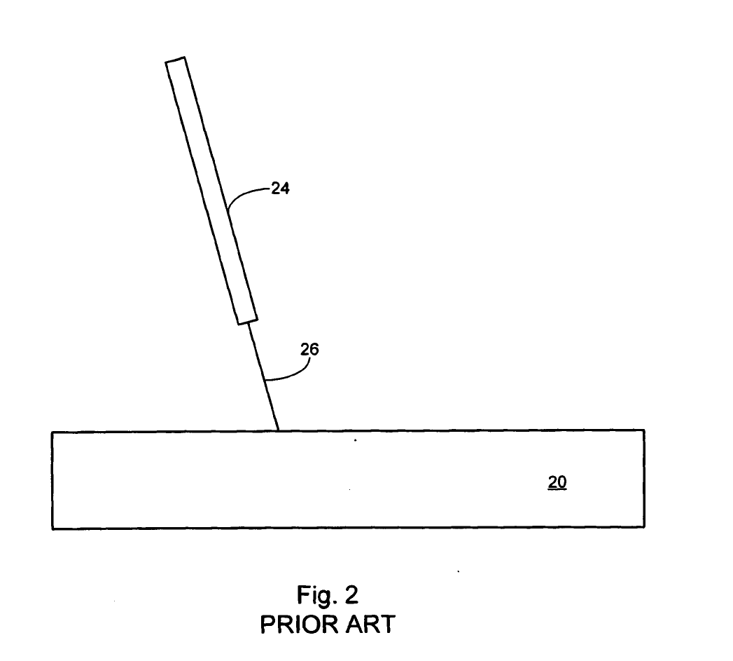

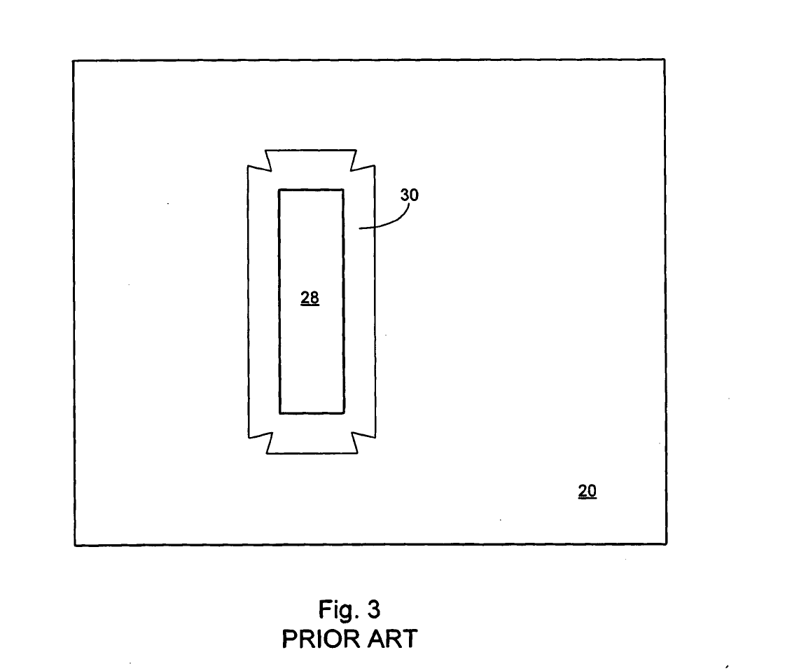

FIG. 1 shows a sample 20 from which a specimen delimitated by a perimeter 22 is to be obtained. As shown in FIG. 2, a FIB column 24 producing an ion beam 26 is used to raster and mill the sample 20 outside the perimeter 22. As shown in FIG. 3, the milling process results in the specimen 28 surrounded by a trench 30 produced by the ion beam 26.

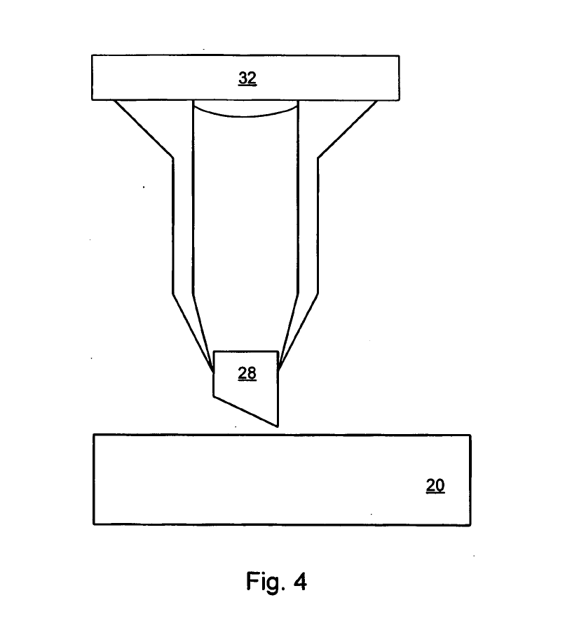

FIG. 4 shows a side view of the sample 20 with the specimen 22 removed from the trench 30 by a manipulator 32. The side profile geometry of the specimen 28 is caused by controlled undercutting by the ion beam 26. The undercutting can be performed from one side producing a wedge shaped bottom as seen in FIG. 4, or from both sides, producing a specimen with a two-bevel bottom (not shown). As is known in the art but not shown in the Figures, it is usual to grab the specimen 28 with the manipulator 32 before milling out the entire outside region of the perimeter 22. That is, the milling process stops before the specimen 28 falls into the trench 30, leaving a bridge of material between the specimen 28 and the sample 20. Once the manipulator 32 grabs or is otherwise attached to the specimen 28, the milling process starts again and mills out the bridge in question. The specimen 28 can then be lifted out of the sample 20 and brought to the carrier grid substrate for attachment.

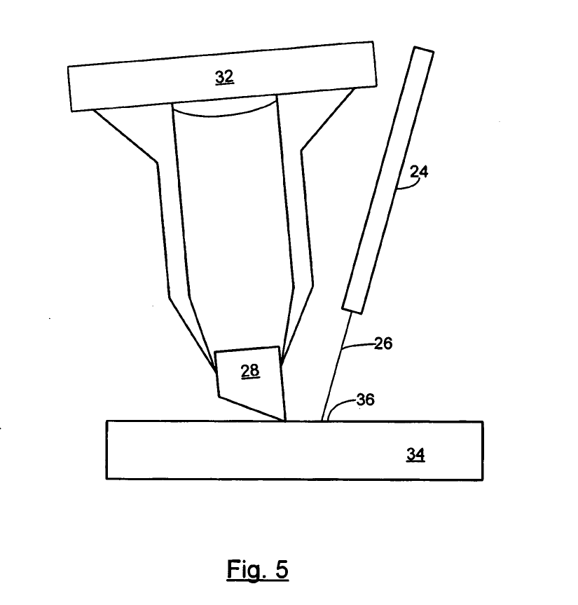

FIG. 5 shows a carrier grid substrate 34 onto which the specimen 28 has been placed by the manipulator 32. The substrate 34 can be, for example, a TEM grid. Once the specimen 28 is in place, the FIB column 24 and ion beam 26 mill-out a target area 36 thereby causing material from the substrate 34 to sputter off the substrate 34 and redeposit over the base of the specimen 28 and on the substrate 34, mostly in the target area 36. This redeposition of substrate material over the specimen 28 and the substrate 34 causes a binding or attachment of the specimen 28 to the substrate 34 and secures the specimen 28 to the substrate 34. Once the specimen 28 is secured to the substrate 34, the manipulator 32 can release the specimen 28. Alternatively, the specimen 28 can be placed on the substrate 34 and released by the manipulator 32 before being secured to the substrate 34 if the specimen geometry and physical properties allow it.

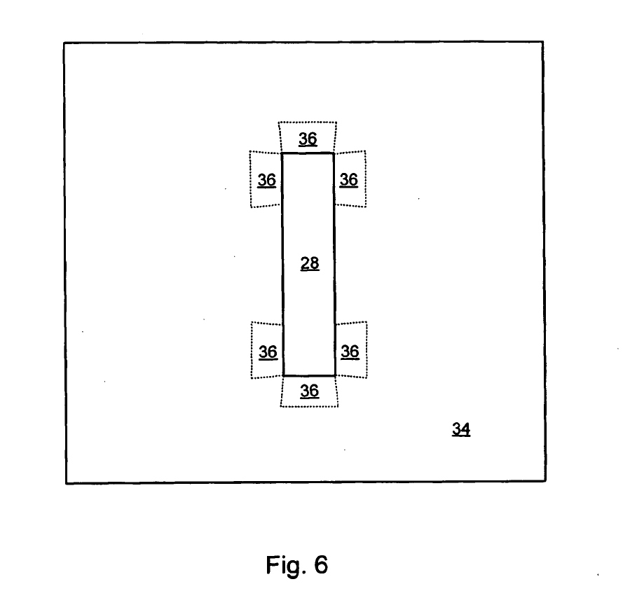

FIG. 6 shows a top view of the specimen 28 secured to the substrate 34 at six target areas 36. As will be understood by the skilled worker, any number of target areas can be used. Depending on the geometry, the mass, the composition of the specimen 28 and of the substrate 34, the number of target areas 36 where the specimen 28 is bound to the substrate 34 will vary.

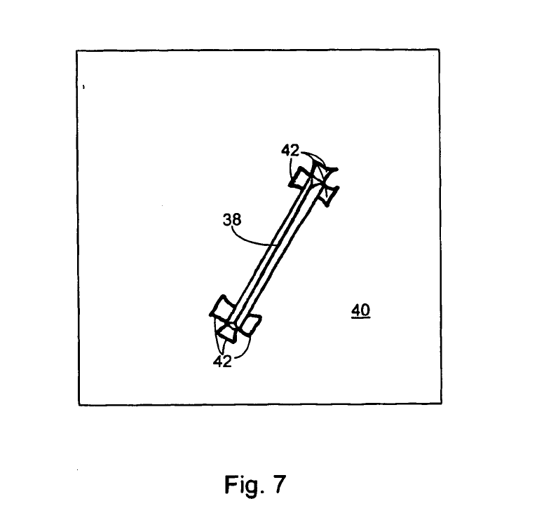

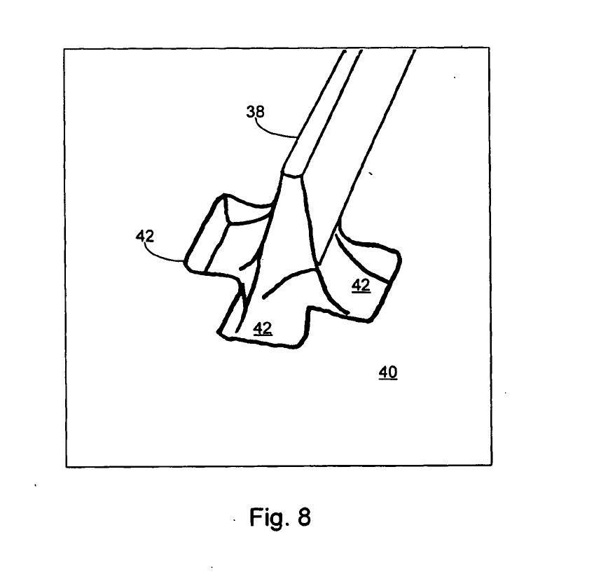

FIGS. 7 and 8 show, as an example of the method described above, an FIB image of a silicon specimen 38 secured to a silicon substrate 40 at target areas 42 by the method described above. Of course, other substrate materials such as, for example copper, molybdenum, boron or boron carbide can be used depending on the analysis application.

Experiments have shown that redeposition rates may be higher when millings insulators such as, for example, silicon dioxide. Accordingly there may be advantages to using a substrate having a conductive region where the specimen can be placed, the conductive region being next to an insulating region of the substrate that can be milled in target areas to produce high redeposition rates. Experiments have also shown that that it is preferable to start the milling process close to the specimen and end farther away in order to maximize the redeposition rate. That is, the edge of the target area where the milling process finishes is the edge furthest from the specimen.

In order to get proper redeposited material, a suitable substrate material should be used. Although adequate rastering (milling) parameters can be found for practically any type of substrate to get sufficient amounts of redeposited material, there are particular advantages to rastering with long dwell times, typically, although not exclusively, in excess of 50 μs per dwell point. Furthermore, certain materials may respond favourably to asymmetric raster spacing, i.e., where the ion beam 26 is moved a different distance between the dwell points in a given line as compared to the spacing between consecutive lines. Still further, those skilled in the art will realize that more favourable redeposition conditions can be achieved by varying the angle of incidence the ion beam relative to the substrate material.

Additionally, depending on the grid material, it can be advantageous to deliver the entire desired ion dose in a single raster pass so as to maximize redeposition. Using a single raster pass also reduces the removal of some of the redeposited material which can occur when scanning the same area multiple times.

It is to be noted that the typical short dwell time (less than 10 μs) “default” milling parameters that typically are programmed into FIB systems by the manufacturer produce very little redeposited material and do not produce that material in a “directional” fashion where it can be made to redeposit on the desired location at the specimen edge or base. Long dwell times and selection of the direction of milling away from the membrane, as discussed above, produce an optimal amount of redeposition in a short period of time and at the desired location for this application.

In the case where the micro-object to be secured to a substrate is not a specimen extracted from a sample as shown in FIGS. 1 to 4, the worker skilled in the art will understand that the steps illustrated in FIGS. 5 and 6 are still applicable. That is, the micro-object is placed onto the substrate and a FIB is used to redeposit material from a target area of the substrate over the base of the micro-object to secure the micro-object to the substrate.

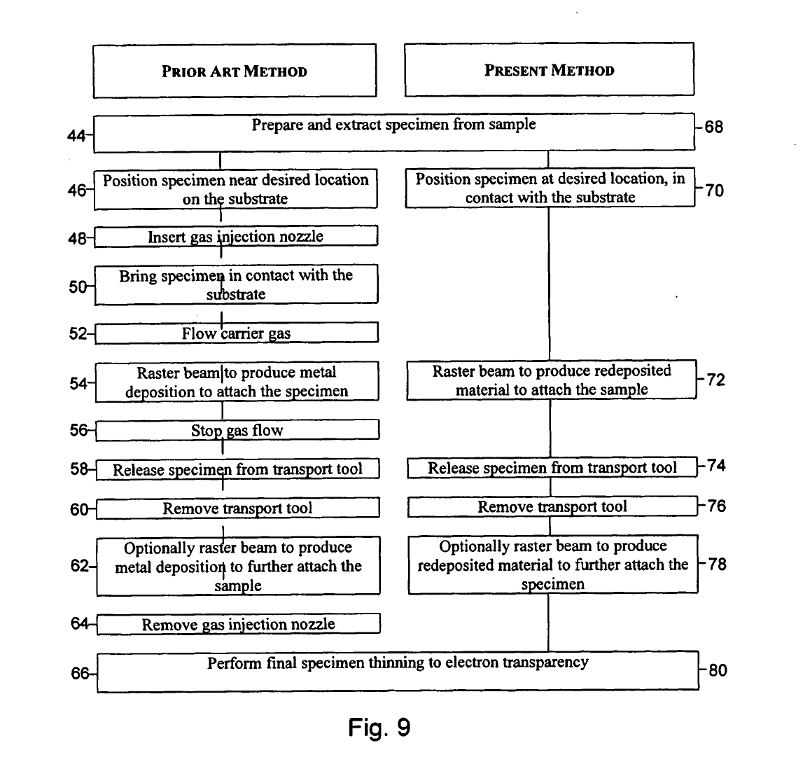

FIG. 9 shows a comparative flow chart for a prior method of securing a specimen to a substrate (steps 44 to 66) and the method of the present invention (steps 68 to 80). The advantage of the present method is clearly advantageous in terms of the number of method steps.

Therefore, the present invention provides a method for attaching a micro-object to a substrate or carrier grid, the method not involving a gas-assisted metal deposition and thus, not exposing the FIB system chamber and its contents to undesirable contaminants. Further, the method of the present invention removes the need to insert and retract a gas injection nozzle in the FIB system chamber, thereby avoiding vibrations and the risk of damage to the sample. Still further, the method can utilize well developed art for manipulating the specimen without the need of a friction or force fit mechanical attachment that can damage the specimen.

The above-described embodiments of the present invention are intended to be examples only. Alterations, modifications and variations may be effected to the particular embodiments by those of skill in the art without departing from the scope of the invention, which is defined solely by the claims appended hereto.

1. A method of securing a micro-object to a substrate, the method comprising steps of:
placing the micro-object on the substrate; and
subjecting a target area of the substrate adjacent the micro-object to an ion beam for removing material from the target area, some removed material from the target area redepositing over the micro-object and the substrate to attach the micro-object to the substrate.

2. The method of claim 1 wherein, the ion beam is a focused ion beam (FIB).

3. The method of claim 2 wherein, the FIB is rastered over the target area in successive steps, the FIB including a current and a dwell time for each step, the current and dwell time being pre-determined in accordance with material properties of the substrate and with physical characteristics of the micro-object.

4. The method of claim 3 wherein, the FIB rasters the target area starting at a position of the target area closest to the micro-object and ending at another position of the target area furthest from the micro-object.

5. The method of claim 3 wherein, the dwell time for each step is at least 50 μs.

6. The method of claim 3 wherein, the target area is rastered in a series of lines, a distance between dwell points in a given line being different from a spacing between consecutive lines.

7. The method of claim 1 wherein, the micro-object is a volume of an electron microscopy specimen produced by nanomachining.

8. The method of claim 1 wherein, the micro-object is an electron microscopy specimen.

9. The method of claim 1 wherein, the micro-object is a specimen taken from a semiconductor wafer.

10. The method of claim 1 wherein, the micro-object is a micro-electromechanical device.

11. The method of claim 1 wherein, the micro-object is a biological specimen.

12. The method of claim 1 wherein, the step of subjecting a target area of the substrate adjacent the micro-object to an ion beam to remove material from the target area, is repeated for at least one more target area.

13. The method of claim 1 wherein, the substrate is one of a conductive and a semiconductive substrate.

14. The method of claim 13 wherein, the substrate includes a metal.

15. The method of claim 13 wherein, the substrate includes boron.

16. The method of claim 13 wherein, the substrate includes boron carbide.

17. The method of claim 13 wherein, the substrate includes silicon.

18. The method of claim 1 wherein, the substrate includes an electrically conductive area and an insulator area, the micro-object being placed at least partly on the electrically conductive area, and the target area includes at least partly the insulator area.

19. The method of claim 1 wherein, the step of placing the micro-object on the substrate is followed by a step of holding the micro-object on the substrate, and the step of subjecting a target area of the substrate adjacent the micro-object to an ion beam is followed by a step of releasing the micro-object.

20. A method of preparing a transmission electron microscopy specimen, the method comprising steps of:
placing the specimen on a substrate;
subjecting a target area of the substrate adjacent the specimen to an ion beam for removing material from the target area, some removed material from the target area redepositing over the specimen and the substrate to the specimen to the substrate; and
subjecting the specimen to the ion beam to remove material obscuring a region of interest of the specimen.

21. The method of claim 20 wherein, the step of subjecting the specimen to an ion beam includes thinning the specimen to electron transparency.
